(19) United States
(12) Patent Application Publication
(10) Pub. No.: US 2009/0166354 A1
(43) Pub. Date: Jul. 2, 2009

(54) Microwave Heating Applicator

(76) Inventor: Per Olov Risman, Harryda (SE)

Correspondence Address: HARNESS, DICKEY & PIERCE, P.L.C., P.O. BOX 8910, RESTON, VA, 20195, US

(21) Appl. No.: 12/086,398

(22) PCT Filed: Dec. 12, 2006
(86) PCT No.: PCT/SE2006/001415

§ 371 Date: Sep. 8, 2008

(30) Foreign Application Priority Data
Dec. 13, 2005 (SE) 0502731-3
Oct. 12, 2006 (SE) 0602147-1

(51) Int. Cl. H05B 6/64

(52) U.S. Cl. 219/690

(57) ABSTRACT

A new, comparatively small type of microwave system based on open-ended applicators is disclosed. The applicator according to the invention uses a main evanescent and a propagating mode in combination, where the combination results in a cancellation of the horizontal magnetic fields at the ends of at least two opposing walls. The effect of this is that the fields propagating out of the applicator become concentrated to the applicator centreline (axis) region, provides an efficient heating of a load or assembly of loads, as well as a stable impedance matching of the system under variable loading conditions due to the mode evanescence, while not leaking energy between adjacent applicators. The applicator can also be used for direct feeding of an underlying small closed metal cavity, for providing (the same favourable) mode conditions to a load in this cavity.

### FIELD OF THE INVENTION

The present invention is related to the field of open-ended microwave applicators. In particular, although not exclusively, the applicators are intended to heat an exterior load which does not need to contact the open end of the applicator. The load may be located in a closed cavity below the applicator, or transported on a conveyor, or the applicator may be moved above the load, or the applicator may be fixed in relation to the load for spot heating of the same. There may be arranged a metal structure below the load in tunnel oven applications, to act as a part of the overall microwave enclosure and also for improving the evenness of load heating.

### BACKGROUND OF THE INVENTION

The prior art microwave applicators which appear to be most similar to those of the present invention are described in the Swedish patent 526 169. Some of the theory behind the present invention is given there.

Due to the need for considerable impedance transformation from the feeding waveguide to the applicator mode, a particular waveguide feed with two slots of opposite field phase is used in the above-mentioned patent. That, in turn, requires a symmetrical applicator mode to have an odd mode index m in the first horizontal (x) direction. Feeding the applicator from the top portion of a vertical side, as described in the U.S. Pat. No. 5,828,040 is normally deprecated for applicator modes with higher m index than 2, due to problems with obtaining heating pattern symmetry in the x direction, and also since many other modes may become excited due to the non-symmetrical feed. Thus, a side feed allows all integer m indices 0, . . . whereas the dual slot symmetric ceiling feed allows only odd m indices. The feed slot location symmetrically between the applicator walls in the other (y) direction allows only odd n indices in that direction.

According to the Swedish patent 526 169, it is concluded that only odd mode index m integers are to be used, for the reasons given above. This and the other design criteria lead to a rather large minimum horizontal applicator opening area. In a typical case for 2450 MHz, this opening area is about 183×306 mm and the mode is TEy₃₁ₑ, where 3 is index m, 1 is index n and the letter e signifies evanescent propagation in the z direction in the applicator. For a definition of rectangular hybrid modes, see below. A sufficiently high power flux density towards the load may then not be achieved with standard 1 kW magnetrons, and larger magnetrons are typically not cost-effective. In addition, this type of applicator does not function well if the distance from its opening to the top of the load exceeds about 100 mm, at 2450 MHz; a substantial spread-out of the field then occurs, in at least two directions.

### SUMMARY OF THE INVENTION

The present invention has been made in view of the desire to design applicators with smaller horizontal dimensions, while retaining the other favourable properties of the applicators according to the Swedish patent 526 169, and in addition to provide possibilities of a single and rather narrow radiation lobe as well as heating of small adjacent areas in other applications. In addition, the inventive applicator should be possible to use as a cavity feed, due to its insensitivity to loading characteristics and its relatively small size.

An object of the present invention is thus to address the above-mentioned problem relating to the need for a smaller applicator opening in relation to the free-space microwavelength.

Some factors to maintain are then:
1. Main mode evanescence, since this provides an insensitivity (of both system resonant frequency and system impedance matching) to the exact loading conditions;
2. A highly predictable heating pattern, making it possible to stagger subsequent applicator rows in a tunnel oven, to obtain an even heating across the tunnel section;
3. A very low spread-out of the field intensity in the x direction below the applicator, so that unpredictable or multimode heating characteristics become insignificant;
4. A very low spread-out of the field in the y direction, for the same reasons as just above;
5. A very low cross-coupling (so-called crosstalk) between adjacent applicators, to retain a high system efficiency as well as avoiding magnetron generators to possibly damage each other, in multi-applicator systems.

In order to facilitate the understanding of the present invention, a summary of some of the theoretical basis will be presented in the following.

The waveguide as well as the so-called cut-off conditions are conveniently studied by introducing a very useful and general parameter called the normalised wavelength v (Greek letter “nu”), where by definition v f_{c}/f=λ/λ_{c}. In this relation, f denote frequencies and λ denote wavelengths. Subscript c is for cut-off, which is the condition when propagation disappears in an infinitely long waveguide, and thus becomes evanescent in the vicinity of the energising zone. With m; n being the mode indices in the x; y directions, and a; b the waveguide dimensions in the same directions, the following equation applies:

v²=(½λ₀)²·[(m/a)²+(n/b)²] (1)

The guide wavelength becomes:

$${λ}_{g} = \frac{{λ}_{0}}{\sqrt{1 - {v}^{2}}} \qquad ( 2 )$$

Equation (1) has a limited number of integer solution pairs (m; n) in each given interval of v. As a consequence, all possible combinations of (m; n)—i.e. modes—for given values of a and b are represented by a finite set of v values. It is to be noted that equation (1) applies for TE, TM and 90° rotated hybrid modes. The condition v=1 is called zero order mode (no field changes occur in the direction of propagation), and is the border case of mode evanescence. Evanescent modes are characterised by v>1 and have an energy decay depth d_{d}, which is the distance in an empty and constant cross section waveguide over which the evanescent mode field amplitude decays by a factor of \sqrt{e} and the energy density of the field by e (to ≈37%). The following applies:

$${d}_{d} = \frac{{λ}_{0}}{4 π \cdot \sqrt{{v}^{2} - 1}} \qquad ( 3 )$$

The basic principle of applicator mode evanescence is maintained in the present invention. A first issue is then if rectangular applicators having modes with smaller index m than 3 are possible to design, while maintaining the other criteria. But wider considerations can also be made, on the use of dielectrics in the applicator, on sloping applicator walls, and on other modes and applicator shapes than rectangular as seen from above. These possibilities are first discussed.

To completely fill the applicator with a dielectric results in maintaining the internal mode properties if all dimensions are also reduced by a factor \sqrt{∈}, where ∈ is the permittivity of the dielectric. This means that the horizontal open area is reduced by a factor E. But since one has also to consider the wave reflections at the open dielectric surface, problems with a requirement of close proximity of the load will have to be considered. Using a high permittivity dielectric is described in, for example, U.S. Pat. No. 4,392,039; the applicator mode is then not evanescent but wave propagation outside it is. This reduces the microwave leakage when the applicator end is in free space, but also requires the load to be very close to the open dielectric end.

The dielectric according to the present invention does not need to fill the whole applicator. Using an at least partial dielectric filling and in principle reducing all applicator dimensions by a factor related to \sqrt{∈} is therefore a possibility, and will also result in a stronger energy coupling to a load near its end, as well as a further reduction of microwave leakage from the applicator away from it and also into adjacent applicators. Dielectric filling is employed according to an embodiment of the present invention.

To vary the cross section of the applicator by sloping walls, i.e. making it non-cylindrical in the mathematical sense, will alter the mode wavelengths. A constant cross section evanescent applicator will have a large energy concentration, and by that larger wall currents, in the feed region. The intensity balance between the two modes which are in co-operation according to the present invention may also be modified by the use of only slightly sloping walls. The two factors above are advantageous, but the mechanical design and assembly becomes more complicated since the preferred embodiment is to make the applicator end narrower than the top end.

As to the use of other horizontal cross sections than rectangular, one has firstly to bear in mind that there is a need for a non-diminishing field intensity in the centre region, since an essentially “focused”, even or striped heating pattern of the load is desired. Using circular arch surface modes (so-called whispering gallery modes) is thus deprecated. But circular TM-like modes with first index 1 is possible, since these modes actually have higher field strengths in the central regions. But using non-rectangular applicators reduces the horizontal surface usage, so that the distance between heating areas increase in comparison with that for rectangular applicators. This results is a reduction of the effective heating rate in tunnel oven applications.

One embodiment of the present invention relates to the use of rectangular TEy modes of the kind described in the Swedish patent 526 169, but having mode index m lower than 3. The co-ordinate directions are given in the appended figures.

The first alternative is m=2. The applicator dimension in the x direction (=a) will then be slightly more than 2×½λ₀, i.e. about 125 mm for the standard ISM band frequency 2450 MHz. With the feed by one y-directed slot centred in the ceiling and a realistically short applicator dimension (b) in the y direction, the possible modes other than the main cross section TEy₂₁ mode are TEy₀₁, TEy₂₃ and TEy₀₃. However, with a b of less than about 200 mm at 2450 MHz, only the TEy₀₁ and TEy₀₃ modes can possibly propagate.

As described in the Swedish patent 526 169, a second propagating mode is needed for counteraction of the magnetic fields (and by that the surface currents) at the two opposing y-directed applicator walls, resulting in a confinement of the downwards propagating energy below the applicator opening (i.e. strong reduction of the spread-out in the ±x directions). Both the TEy₀₁ mode and partially also the TEy₀₃ mode can fulfil this.

One aspect of the present invention is how confinement of the fields emanating from the applicator is achieved. This confinement results in low mutual coupling to adjacent applicators, and in the present case also leads to a single “radiation lobe” along the vertical centreline of the applicator. A condition for this confinement is that there would be minimal total inner wall vertical currents at the applicator opening if it were continued downwards (in the +z direction). This z-directed current is determined by the total x- and y-directed H fields along the y- and x-directed wall ends, respectively, since the current density is given by the vector relation J=ñ×H, where ñ is the normal to the wall surface.

With reference to FIG. 2a of the drawings, and the waveguide theory given, for example, in R. F. Harrington “Time-Harmonic Electromagnetic Fields”, McGraw Hill Book Co., 1961, p. 152-155, some principles of the mode structure can be explained.

The referenced section of the Harrington book deals with rectangular hybrid modes, including definitions and nomenclature. Basically, such a TE or TM “mode to z” has to lack the z-directed E and H component, respectively. Most rectangular modes can be “rotated” so that they lack a component in another direction than that of the main propagation. Such modes are called hybrid modes and are labelled TEx, TMy etc. Note that the simplest (so-called normal) mode, TE₁₀ has only two H and one E component; it is therefore formally “its own hybrid mode”.

Hence, again referring to FIG. 2a and to the Harrington book, a factor 1−(nλ₀/2b)² appears in the expressions for the TEy mode, where the mode index in the y-direction is given by n and the applicator length in this same direction is b. Only if the expression nλ₀/2b is small will the mode have the desired low z-directed impedance, i.e. a TMz-like behaviour. In the present case, n should be as small as possible (1) and b should be comparatively large (about λ₀ or larger). The horizontal H field along the y-directed wall sides may then be approximated by the standard expression for TMz modes:

$${H}_{y} = ∓ A \cdot \frac{m}{a} \cdot cos ( \frac{m π x}{a} ) \cdot sin ( \frac{n π y}{b} )$$

where the mode index m is in the x direction, and A is a normalized amplitude. Since m=2 and n=1 in this case, at the applicator walls (x=0; x=a) the following expression is obtained for H_{y}:

$${H}_{y} = ∓ A \cdot \frac{2}{a} \cdot sin ( \frac{π y}{b} )$$

In analogy, the horizontal H field along the x-directed wall sides becomes:

$${H}_{x} = \pm A \cdot \frac{1}{b} \cdot sin ( \frac{2 π x}{a} )$$

With a minimal a dimension slightly larger than AO, for establishing a suitable mode evanescence, and a significantly larger b dimension of about 1.5·λ₀, it is evident that H_{y} becomes significantly larger than Hₓ, by a factor of about 3.

With reference now to FIG. 2b, the TEy₀₁ mode is not a hybrid mode; it is the same as the TEz₀₁=TE₀₁ mode, with m=0 and n=1. The horizontal H field along the y-directed wall sides becomes:

$${H}_{y} = \pm B \cdot \frac{\sqrt{1 - {v}^{2}}}{b} \cdot sin ( \frac{π y}{b} )$$

where v=f_{c}/f is the normalised wavelength, f_{c} is the mode cut-off frequency, and f is the operating frequency. The H field along the x-directed wall sides becomes Hₓ=0 (zero). In view of this, for the field confinement by the applicator, it is preferred that Hₓ of the TEy₂₁ mode is as small as possible. This may be achieved by the choice of a minimal a and a large b dimension, as described above.

It should also be noted that, whereas the evanescent TEy₂₁ mode is confined and in particular has no spatial phase, the TEy₀₁ mode is propagating and will therefore have a variable amplitude at the applicator opening. But since this mode has a much higher impedance, it will typically be relatively strongly reflected by a load adjacent to the applicator opening. The applicator height should therefore be selected to provide conditions of minimal (x-directed) E field at the opening, which maximises the compensating H_{y} field there. In view of the TEy₀₁ mode wavelength (in the z direction) being close to λ₀, the load plane (i.e. where the load is to be placed) should preferably, in order to minimise the cross-coupling, be about λ_{g}(¼+p·½) below the applicator ceiling, where λ_{g} is the wavelength of the TE₁₁ mode in the applicator and p is an integer chosen so that the distance from the applicator opening is realistically small.

The second alternative is m=1. In this case only the TEy₀₁ and TEy₀₃ modes are possible. However, these modes cannot fulfil the criterion on counteraction of the magnetic fields and by that the surface currents at the two opposing y-directed applicator walls. Additionally, there will be no Poynting vector maximum at the z-directed centreline. As a consequence, m=1 cannot typically be used in embodiments of this invention.

As a further alternative, other mathematically cylindrical cross sections than rectangular can of course be used, provided they allow nulling of horizontal H fields in the applicator opening periphery region.

Field confinement of the fields emanating from the application will now again be discussed, this time for non-rectangular applicators, using an analogy to the rectangular applicators.

Since the circular applicator shape will be of some importance, it will be particularly dealt with below, with reference to FIG. 2c.

It is to be observed that there are no circular hybrid modes as in the rectangular case, since the circular modes considered here have no so-called mode degeneracy. Thus, there are only TEz and TMz modes.

The field patterns of the TM₁₁ and TE₁₁ modes are shown in FIG. 2c. The former is the evanescent main mode, and the latter is the helper mode intended to provide minimal total inner wall vertical currents at the applicator opening if it were continued downwards (in the +z direction).

It should now be noted that, since the modes have the same m index, the circumferentially directed H_{φ} fields get the same φ dependency sin φ. This means that complete nulling along the whole periphery is theoretically possible, as opposed to all other mathematically cylindrical geometries.

It is also to be noted that under conditions of complete nulling of the H_{φ} field, two quite remarkable applicator properties occur:
1. The first is an extremely narrow radiation lobe, in fact so narrow that no appreciable field spread-out occurs even five wavelengths or more away from the opening, under free space conditions or in a halfspace low-loss load; as a matter of fact, the properties of geometric optics systems are surpassed.
2. The second is an extremely small microwave leakage sideways from the applicator, in spite of its free space or load irradiation.

However, in order to exploit these phenomena, one has to realise that the TE₁₁ mode is propagating and will therefore have a variable amplitude at the applicator opening. But since the evanescent TM₁₁ mode has such a low impedance that its behaviour becomes “Brewster-like”, it will propagate with low reflection across a plate or similar with quite high permittivity. Such a plate can thus be chosen and located for strong reflection of the TE₁₁ mode, while allowing the TM₁₁ mode to propagate through. The applicator height is normally chosen to provide conditions of minimal (x-directed) E field at the opening, which maximises the H_{y} field there. In view of the TEy₀₁ mode wavelength (in the z direction) being about 1.15·λ₀, the plane of the plate should therefore preferably be about 1.15·λ₀(¼+p·½) below the applicator ceiling, where p is an integer chosen so that the distance from the applicator opening is realistically small.

The modes employed in the above type of applicator may be generalized to TE₁ₙ and TM₁ₙ modes, where n is the radial mode index. According to the above, n=1 is the preferred selection, i.e. TE₁₁ and TM₁₁.

As to other non-rectangular geometries, there may be practical reasons for choosing e.g. hexagonal cross sections. These will give the least cross-coupling if regular. Even if other cross sections, such as elliptical, are possible within the scope of this invention, practical manufacturing issues may render these less preferred. More generally, the applicator may be designed with a wide range of cylindrical geometries, the applicator having a general radial (ρ) dimension and a longitudinal (z) dimension, wherein the applicator comprises a centred feeding slot in the ceiling of the applicator, connecting the applicator to a TE₁₀ feed waveguide; and wherein said dimensions are selected such that the applicator supports, at said predetermined frequency, a first evanescent TM₁ₙ-like (or TM₁₁-like) mode and a second propagating TE₁ₙ-like (or TE₁₁-like) mode, wherein subscript n is the radial mode index. As will be understood, the modes are here expressed generally as TEₘₙ and TMₘₙ using the standard designation for circular modes. For a circularly cylindrical applicator, the modes may be the pure TM₁₁ and TE₁₁ modes shown in FIG. 2c (or more generally, TM₁ₙ and TE₁ₙ modes, where n is the radial mode index). For other kinds of generally cylindrical applicator geometries, these modes will be distorted, but still TM₁₁-like and TE₁₁-like, with two H field loops in the applicator cross section. For a non-symmetric applicator geometry, such as an elliptic applicator cross section, it is preferred that the feeding slot is directed parallel to the major axis of the applicator cross section.

However, either elongated rectangular cross sections with the coupling slot in the direction of the longest applicator side, or circular cross section are the currently most preferred embodiments.

### BRIEF DESCRIPTION OF THE DRAWINGS

The geometrical definitions and the features of the present invention are illustrated on the following appended drawings, on which:

FIG. 1 shows a perspective view of an arrangement of three rectangular applicators according to the present invention, including a definition of co-ordinate directions;

FIG. 2a shows a perspective view of the dominating TEy₂₁ fields;

FIG. 2b shows a perspective view of the TEy₀₁₂ fields, in a rectangularly cylindrical applicator according to the present invention;

FIG. 2c shows field patterns in a circularly cylindrical applicator;

FIG. 3 shows a perspective view of a circularly cylindrical applicator according to the present invention;

FIG. 4 shows a single rectangular applicator according to the present invention; and

FIG. 5 shows an applicator coupled to a cavity, according to the present invention.

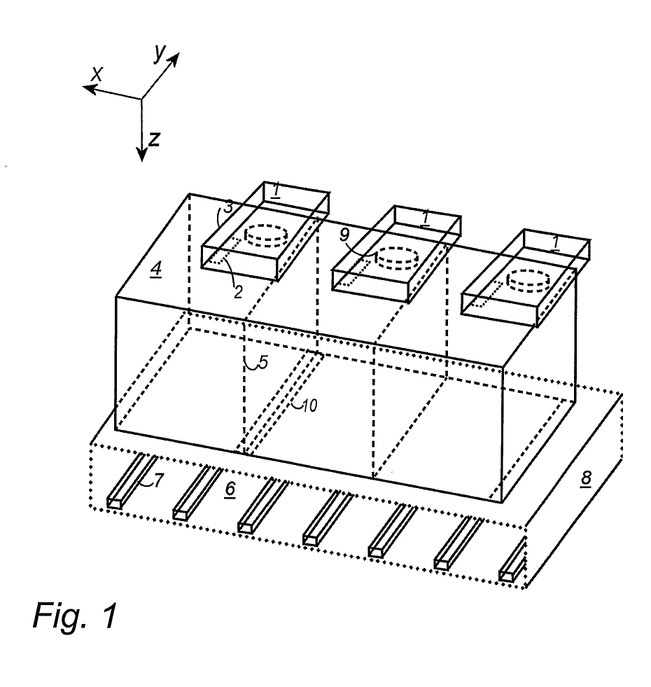

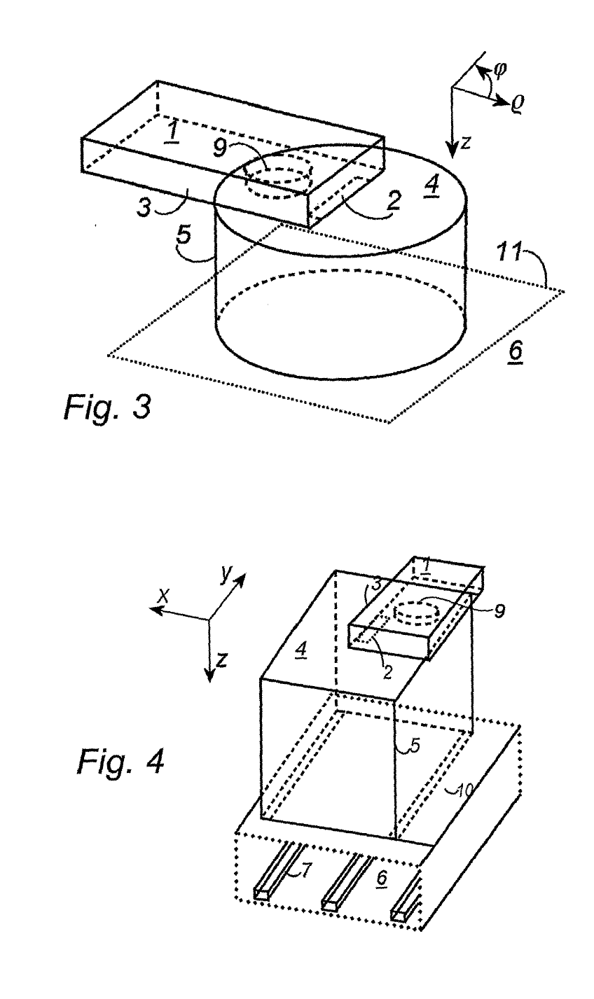

On the drawings, parts or elements that are similar or perform similar functions or have similar effects are generally designated by the same reference numerals throughout. It is to be understood, however, that elements having the same reference numeral need not be identical; for example, reference numeral 5 is used for the applicator wall both for the rectangularly cylindrical embodiments of FIGS. 1 and 4, and for the circularly cylindrical embodiment of FIG. 3. Any such minor differences between the various embodiments of the present invention should be clear from the drawings and the detailed description below.

### DETAILED DESCRIPTION

One embodiment of an applicator according to the present invention will now be described, with initial reference to FIGS. 1 and 4. FIG. 1 shows three adjacent applicators, while FIG. 4 shows a single, stand-alone applicator. Each of the applicators 4 is fed by a slot 2 along a side wall 3 near the end shorting wall of a normal rectangular TE₁₀ waveguide 1. The other end of the waveguide continues to a transition section to the microwave generator. These parts are not shown, since such arrangements are readily understood by anyone of ordinary skill in the art. For impedance matching reasons, there is provided a metal post 9 centrally in the feeding waveguide 1. The applicators are open at the bottom end, into a space 6 where the load to be treated (not shown) should be located. Adjacent applicators have a common side wall, such as the side wall indicated at 5, and there may also be horizontal metal flanges 10 welded at the end of one or several walls 5. The function of the flanges 10 is to limit the spread-out of the field in the ±x directions, primarily in the case of multiple applicators being located with common side walls as shown in FIG. 1. They are then designed by experiment, for optimising the overall power flux density towards the underlying load(s). The applicator arrangement may be staggered sideways, with a following triplet in the y direction having the larger space 8 of the load or tunnel space 6 on the other side. There may be rails 7 of metal or dielectric material at the bottom of the tunnel space 6.

The choice of a rectangular applicator having more field spread-out in the ±x directions may be suitable for tunnel systems as described above. However, for spot-heating of individual load items, as well as for applicator use as a radiating antenna into an empty space between the applicator and the load, the square shape may be preferred, since the cross-coupling to adjacent applicators is in such case minimised without any flanges 10.

The general outline of the applicators 4 with walls 5, flanges 10, load space 6, staggering and rails 7 is essentially similar to that disclosed in the Swedish patent 526 169. Also the particular, large metal post for impedance matching is similar to that in the abovementioned Swedish patent. However, according to the present invention, the feeding slot 2 and its location in the waveguide 1, as well as the size of the applicators, and as a consequence also the applicator modes, are different. This post has an inductive action, and has the purpose of providing the required compensation of the excess capacitive energy of the evanescent main mode.

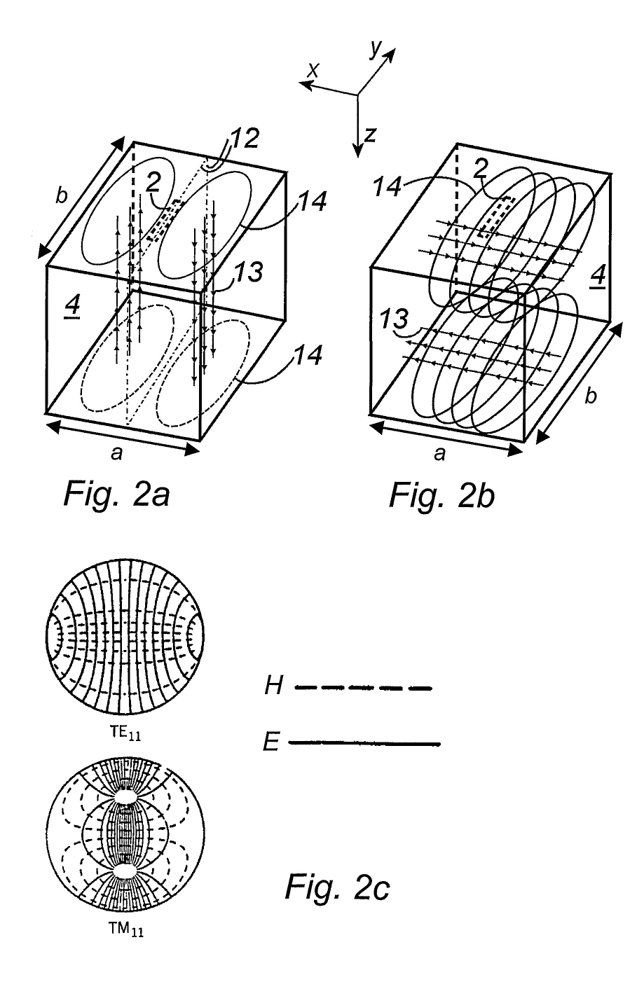

FIG. 2a is intended to illustrate some features of the evanescent TEy₂₁ₑ mode. As an example of a preferred embodiment for 2450 MHz operation of the present invention, the x-directed applicator dimension a is 128 mm and the y-directed dimension b is 190 mm. The primary induced field is magnetic (H), as illustrated by the ovals 14. The field polarities are reversed at half the a distance 12. There are, however, difficulties to illustrate the H field intensities; firstly since the quotient of the maximal H_{y} and Hₓ intensities is mb/na to the first order, and secondly since the mode evanescence causes a weakening of the H fields along the z direction. In this preferred embodiment case, mb/na becomes almost 3, and the z-directed distance over which the energy density decays by a factor e⁻¹ becomes about 150 mm.

A further item of importance is that the downwards-directed (z) Poynting vector depends on the horizontal electric E field component, which in this case is Eₓ, since E_{y} is zero due to the mode being of hybrid TEy kind. The z-dependent behaviour of Eₓ is complicated, due to the fact that the forwards and backwards evanescent waves are not orthogonal as is the case for normally propagating modes. Actually, the Eₓ component becomes essentially independent of z, and of about the same amplitude at the applicator opening as the dominating E_{z} component which is illustrated by the vertical arrow-lines 13 in FIG. 2a. This component decays approximately exponentially towards the applicator opening, in the same way as H_{y}.

FIG. 2b is intended to illustrate some features of the propagating TEy₀₁₂ mode. There is no variation of the intensities in the x direction, so the mode is actually the same as the TEz₀₁₂ mode.

When the TEy₂₁ₑ and TEy₀₁₂ modes are both excited by the slot 2, the H_{y} polarities at the open end of the walls x=0 and a become opposed, as do the Eₓ polarities there, provided the applicator height is such that it approximately supports the TEy₀₁₂ mode inside. As a result, almost only H_{y} and Eₓ in the central opening area remain and propagate downwards (z) away from the applicator.

Resonance at a desired frequency of the system, comprising the applicator and a short empty region followed by the load to be treated below, can be accomplished with the right choice of the three applicator dimensions as parameters, an example being the x,y data for a preferred embodiment given above, with a z-directed applicator height of 115 mm. This is slightly shorter than the guide wavelength of the TEy₀₁ mode: 140 mm at 2450 MHz. Hence, the mode index p in the z direction becomes slightly less than 2, but the mode will become favourably resonant with a load top located about 35 mm below the applicator opening. This shorter wavelength than the applicator height will also give the best applicator properties in terms of minimised cross-coupling between applicators, and minimised side lobes or radiation into an empty airspace.

For system matching, a substantial impedance transformation is needed, in analogy to the cases described in the Swedish patent 526 169. This is achieved by several means, such as using a low height for the feeding TE₁₀ waveguide 1, a quite short slot 2, and a quite large metal post 9. Combinations of data of these and applicator dimensions can be used to optimise the downwards “focusing” and minimising the cross-coupling between adjacent applicators.

Another alternative giving slightly less “focusing” and a lower quality factor (Q value) of the system, and which may be suitable for certain applications, is 135×135 mm, with unchanged height 115 mm.

Another preferred embodiment is a square applicator with 130 mm sides and 105 mm height. Actually, this applicator provides a better function than the above-mentioned rectangular applicator with regard to minimising the external field away from the opening in the ±x directions in the plane of the opening. The square cross section version has a half-power lobe angle of 43° in the x plane and 47° in the y plane, as determined by numerical microwave modelling; the lobe is then defined in an empty space plane parallel with the opening plane at 350 mm distance, and not as a solid angle Ω as for communication use far away from the antenna.

The rectangular applicator 128×190 mm and 115 mm high has a half-power lobe angle of 52° in the ±x directions and 32° in the ±y directions. However, there are more side lobes in the ±y directions for the rectangular than for the square applicator.

Other mathematically cylindrical cross sections than rectangular can of course be used, as mentioned in the summary above, provided they allow the same nulling of horizontal H and E fields in the applicator opening periphery region.

The simplest, and a practical example, of a non-rectangular applicator is a circular cross section. Such a system is illustrated in FIG. 3. The slot 2 in the waveguide 1 is now at the shorting wall and not along the side 3. The applicator 4 has circular walls 5 and opens up at a plane 11 into the region 6 where the load to be treated (not shown) is located. A 2450 MHz preferred embodiment of this version has an applicator diameter (ρ dimension) of 144 mm and height (z dimension) of 95 mm. The evanescent mode is now TM₁₁, having an energy decay distance of about 75 mm. The compensating mode is TE₁₁, having a wavelength of about 140 mm.

There may also be arranged a ceramic place below the applicator. In one example, the ceramic plate has a thickness of 10 mm and a permittivity of about 8. The plate is located about 40 mm below the applicator. The positioning of the plate has been discussed in the summary above, and the thickness is preferably such that it becomes ¼ of the plane wave wavelength inside, i.e. λ₀/(4·√∈). The plate is square, with a side length of about 185 mm. It performs the intended function by reducing the “leaking” H_{y} field by a factor more than 3, to a practically insignificant level. There are no other significant sideways propagating fields.

Applicator configurations such as this are useful for directed irradiation of large loads in large industrial tunnel ovens for minimising shadowing effects, and also in power transmission systems. They can also be employed in various measurement systems. Due to the inherent applicator narrowband properties, the frequency bandwidth of such systems is of course quite limited. Non-limiting examples of feasible applications are free space power transmission, proximity radars and measurements of scattering and material properties, with single or multiple applicator set-ups.

When implementing embodiments of this invention, it may be noted that using rectangular applicators with pairs of modes TEy_{m;1;e} and TEy_{(m-2);1;e} with even integer m>2 (m=4, 6, . . . ) does not provide any significant advantages, due the difficulties of keeping the two working modes undisturbed with a single slot feed and the added complexities to design a multislot symmetrical feed for eliminating odd index m modes. As stated in the Swedish patent 526 169, odd index m mode sets are then to be preferred.

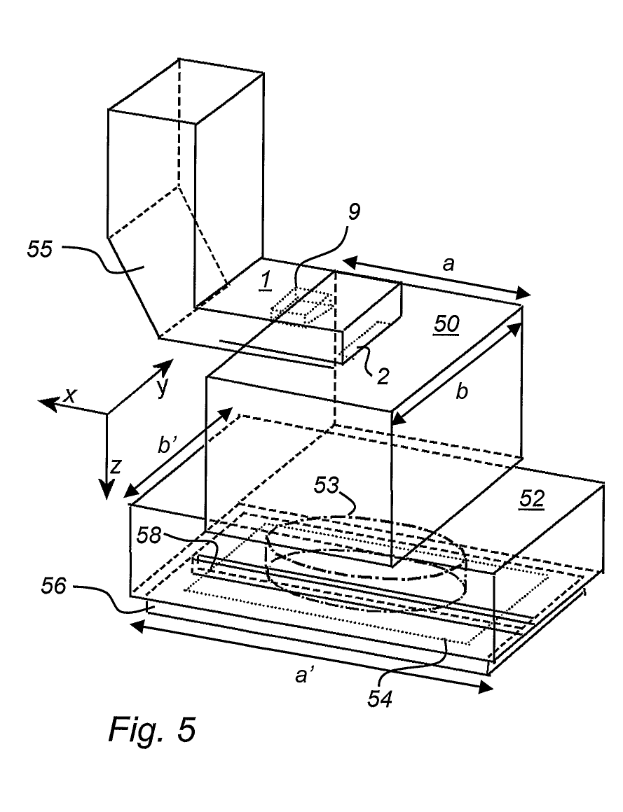

A more complete system incorporating an applicator as described above will now be described with reference to FIG. 5. Such system comprises the applicator 50 with a directly fed, closed metal cavity 52 below and is shown in FIG. 5. In this case, the applicator 50 is 128×190 mm (a×b) horizontally and 115 mm high. The cavity 52 is 250×160 mm (a′×b′) horizontally, and centrally located below the applicator and with its short side in the direction of the 190 mm applicator dimension. The cavity has a microwave-transparent (glass) shelf 54 about 65 mm from the ceiling plane, and an airspace 56 below. This is slightly smaller than the cavity 52 horizontally, and about 13 mm deep. On the bottom of this space there is a contacting, centred, 10×10 mm cross section metal rod 58. The load 53, which may be a portion of food or a food item, is located on the shelf 54 for heating. The cavity 52 may have a normal hinged, or a vertically sliding, door (not shown) for access. The system may be a free-standing microwave oven, or be built into a vending machine or similar. Particularly, the cavity is preferably designed such that the cavity mode is of essentially zero order, i.e. having a vertical index of 0, and wherein the mode indices n_{c} and m_{c} for the cavity are n_{c}=1 and m_{c} greater than the corresponding applicator m index.

Similar to the cases shown in FIGS. 1 and 4, the applicator is fed by a waveguide 1, opening to a feeding slot 2 in the ceiling of the applicator. A metal post 9 is also provided in the waveguide 1 for impedance matching reasons. Although not shown, the waveguide is of course coupled to a microwave generator, such as a magnetron, which is connected at the vertical top part of the waveguide. This has a combined E knee and transformation section 55 to a larger internal height suitable for the purpose.

An elongated rectangular applicator such as that with opening dimensions 128×190 mm has a minimised cross-coupling to an adjacent applicator in the y direction, and is therefore suitable for use in tunnel ovens. It is also useful in systems where the applicator is directly connected to a cavity below, such as shown in FIG. 5. This is because the x-directed half-wavelength in the applicator is then closer to (½)λ₀ and this accomplishes a better field matching to a z-directed zero order cavity mode. In the example according to FIG. 5, the related cavity dimension is 250 mm, i.e. the half-wavelength is 62.5 mm which is very close to (½)λ₀ (which is 61.2 mm) at a frequency of 2450 MHz.

Due to the strong internal resonance of the applicator and the full opening between the two, this will largely determine the cavity field. This means that the system resonance will be quite independent of the cavity load; a quite unusual condition for single-mode systems. Another characteristics is then the very high z-directed E field, and yet another is the very low vertically directed impedance of the applicator and cavity fields. The latter will cause Brewster-like (non-reflecting) conditions at the load, even if it has a quite high permittivity.

With reference to FIG. 5, the cavity field pattern is thus essentially that of the applicator TEy₂₁ mode, but due to the cavity size it is “filled up” to a TEy₄₁ mode there. It is also of some importance that the simultaneously excited TEy₀₁ mode is out of phase with the TEy₂₁ mode, at the load. This is favourable, since the vectorial field addition will then to some extent result in the maxima of the horizontal fields to become spatially moving, and thus even out in particular any so-called cold-spot areas of the load.

The resulting heating pattern from the TEy₄₁ mode impinging from above to a high permittivity load is basically that of the dominating H field pattern. This is in the direction of the long dimension of the applicator, due to the field amplitude factor (m/a)/(n/b) being large, (2/128)/(1/190)≈3 in this case. Unless the load itself causes significant diffraction or surface wave effects, the heating pattern “from above” will thus be striped, with a tendency of an additional central heating spot caused by the applicator “radiation” pattern.

If the load has a low permittivity, a particular phenomenon related to the objects of the present invention occurs: direct heating by the strong vertically directed (E_{z}) field above. For this to occur and be of practical significance, the mode should be of the low impedance TM type and close to or at evanescence, for maximising this field in relative terms. Furthermore, the load permittivity should be low, typically 5 or below, due to the requirement on continuity of a perpendicular D field component at the interface, which reduces the E field strength by a factor about ∈′ (the permittivity) There is, however, a major advantage with this E_{z} field: it is displaced from the horizontal magnetic field causing the normal H-field-induced heating pattern by a quarter wavelength, and it is also orthogonal in the frequency domain. This means that the added heating by the direct influence of the E_{z} field is arithmetically added to that of the normal H-field-induced heating pattern. The result is a significant overall improvement of the heating pattern. When a food load is to be defrosted and heated in a single process, the fact that the direct E_{z} heating pattern is strong in some parts of the load results in an earlier defrosting of these parts. This effect strongly reduces the cold-spot effect later in the process, since these pre-defrosted parts will then have a higher absorption capability than their surroundings.

The “cavity recess” with metal rod has the function of creating suitable so-called underheating (longitudinal section standing magnetic, LSM) waves which enhance the evenness of heating, by providing a significantly different heating pattern from below. The associated effects are known per se; see for example Risman, P. O., “Confined modes between a lossy slab load and a metal plane as determined by a waveguide trough model”, in J. Microwave Power & Electromagnetic Energy, 29(3), p. 161-170; and U.S. Pat. No. 4,816,632. LSM waves have an important property: a lower permittivity part of a load (such as a still frozen part) absorbs the wave energy more strongly than a higher permittivity part. Again, a favourable compensation effect occurs with food loads being defrosted and heated in a single process.

Providing conditions for excitation of strong LSM modes is thus highly preferred. What is required for this is a feed by external fields with very low vertical impedance and strong vertical electric (E_{z}) field. It is apparent from the foregoing that these conditions can be fulfilled with the presently disclosed cavity and feed system. The dimensions of the applicator and cavity system described above is merely an example which fulfils the criteria discussed above. The applicator can have other dimensions. In particular, the cavity height can be different or even variable, to optimise the heating evenness for chosen sets of load geometries and permittivities. As an example, for heating from chilled temperature of a rectangular 400 gram food pack with horizontal dimensions, increasing the cavity height from the 65 mm previously given, for defrosting and heating in a single process an increase to about 85 mm cavity height will provide an improvement. It is then of importance that the impedance matching of the system remains essentially unchanged for such cavity changes, due to the particular resonant properties of the applicator. This allows the height changes to be made also by unqualified personnel without access to microwave measurement instrumentation and other associated experimental resources; a complete system designed for easy such cavity height changes is simply modified by experiments with actual food loads. Sliding door operation is then preferred, as are suitable capacitive seals and chokes around the cavity periphery. Such designs can be made by anyone of ordinary skill in the art.

As is evident from the foregoing, the applicator-cavity system may be designed to perform well in spite of the fact that there are no moving parts of or in the system. This is of course a very favourable and cost-saving feature of the system, in particular for vending-machine type applications.

It should be understood that a rectangular applicator according to above relates to any such applicator geometry in which there are pairs of generally parallel applicator walls. The term “rectangular applicator” does not exclude the possibility of having rounded or bevelled corners between the applicator walls.

The skilled artisan will also understand that, while the foregoing description has primarily referred to an ISM operating frequency of 2450 MHz, the teachings of the present invention can be applied for any operating microwave frequency. In order to modify the examples given above to other operating frequencies, dimensions should be linearly scaled according to the frequency ratio. For example, in order to apply the teachings of this invention for the operating frequency of 915 MHz, all lengths and dimensions should be scaled by 2450/915.

### CONCLUSION

A new, comparatively small type of microwave system based on open-ended applicators has been disclosed. The applicator according to the invention uses a main evanescent and a propagating mode in combination, where the combination results in a cancellation of the horizontal magnetic fields at the ends of at least two opposing walls. The effect of this is that the fields propagating out of the applicator become concentrated to the applicator centreline (axis) region, provides an efficient heating of a load or assembly of loads, as well as a stable impedance matching of the system under variable loading conditions due to the mode evanescence, while not leaking energy between adjacent applicators. The applicator can also be used for direct feeding of an underlying small closed metal cavity, for providing (the same favourable) mode conditions to a load in this cavity.

1. A cylindrical microwave applicator operating at a predetermined frequency, the applicator having a general radial (p) dimension and a longitudinal (z) dimension, characterised in that the applicator comprises a centred feeding slot in the ceiling of the applicator, connecting the applicator to a TE1o feed waveguide; and in that said dimensions are selected such that the applicator supports, at said predetermined frequency, a first evanescent TM1ₙ-like mode and a second propagating TE1ₙlike mode, wherein subscript n is the radial mode index.

2. The applicator as claimed in claim 1, wherein the radial mode index n is equal to 1.

3. The applicator as claimed in claim 1, wherein the evanescent mode has an energy decay distance approximately equal to the longitudinal (z) dimension of the applicator.

4. The applicator as claimed in claim 1, further comprising a metal post arranged centrally in the waveguide near the feeding slot.

5. The applicator as claimed in claim 1, wherein the applicator is at least partially filled with a comparatively low permittivity dielectric in order to reduce its overall dimensions.

6. The applicator as claimed in claim 5, wherein the applicator is completely filled with a low permittivity dielectric, preferably having a permittivity of 5 or less, more preferably 3 or less.

7. The applicator as claimed in claim 1, wherein the applicator is designed with a decreasing cross section along its length from the feed opening.

8. The applicator as claimed in claim 1, wherein the applicator has a circularly symmetric cross section, and wherein the applicator dimensions are selected such that the applicator supports, at said predetermined frequency, a first evanescent TM₁ₙ mode and a second propagating TE₁ₙ mode, wherein subscript n is the radial mode index.

9. The applicator as claimed in claim 1, wherein the applicator has a hexagonal cross section.

10. The applicator as claimed in claim 1, wherein the applicator has an elliptic cross section, and wherein the feeding slot is directed parallel to the major axis of the applicator cross section.
